(19) United States
(12) Patent Application Publication
(10) Pub. No.: US 2019/0035292 A1
(43) Pub. Date: Jan. 31, 2019

(54) EDUCATIONAL TOY SYSTEM

(71) Applicant: Clifton Palmer, ON (CA)

(72) Inventor: Clifton Palmer, ON (CA)

(21) Appl. No.: 15/665,297

(22) Filed: Jul. 31, 2017

(51) Int. Cl. G09B 1/24; G09B 1/06; A63F 9/00

(52) U.S. Cl. CPC G09B 1/24; A63F 2250/16; A63F 9/001; G09B 1/06

(57) ABSTRACT

An educational toy system includes a plurality of flexible fabric sheets having indicia arranged in combination on at least one surface structured and arranged to promote child recognition and for educational purposes. Each of the flexible fabric sheets comprises a unique color, shape, at least one letter, at least one number, words, symbols or a combination thereof for child recognition and learning.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of educational devices and more specifically relates to an educational toy system.

### 2. DESCRIPTION OF RELATED ART

Various types of educational devices for young children are known in the prior art, including some which are designed to teach the alphabet or numbers and to teach color recognition and the recognition of shapes. Separate teaching devices are employed to accomplish these multiple objectives and many of the devices are mechanical or electromechanical in nature and tend to be somewhat complicated and costly. Many are not practical for the young child to utilize directly and require demonstration or operation by the teacher. A suitable solution is desired.

U.S. Pat. No. 4,378,214 to Marion W. Scherer relates to a multi-purpose educational device. The described multi-purpose educational device includes a multi-pocketed washable fabric body portion which is employed with several selective reversible fabric strips each having fastener components for engagement with mating fastener components on the body portion. The strips carry colors, shapes, alpha-numeric indicia and material textures requiring recognition by a child. Groups of fabric elements having colors, shapes, indicia and textures to match up with the strips are provided, and a child, after sorting the fabric elements, inserts them in the pockets of the body portion which are positioned adjacent to recognized colors, shapes, indicia or textures on the strips.

### BRIEF SUMMARY OF THE INVENTION

In view of the foregoing disadvantages inherent in the known educational devices art, the present disclosure provides a novel educational toy system. The general purpose of the present disclosure, which will be described subsequently in greater detail, is to provide an effective learning device for children.

An educational toy system is disclosed herein. The educational toy system includes a plurality of flexible fabric sheets having indicia arranged in (arrangeable on) combination on at least one surface structured and arranged to promote child recognition and for educational purposes. Each of the flexible fabric sheets comprises a recognizable shape, each of the flexible fabric sheets comprising a front-surface and a back-surface and at least one side. The educational toy system is configured for modular use of the plurality of flexible fabric sheets such that each of the flexible fabric sheets, when strategically placed, can provide a child-based-query to provoke thought to form and relay an answer as to the child-based-query. The present invention does not comprise pocket(s) in preferred embodiments.

Each of the flexible fabric sheets includes indicia which may include at least one letter, at least one number, words, symbols or a combination thereof of useful (configured for and/or structured and arranged to) for child recognition and the educational purposes. The flexible fabric sheets may further comprise a unique color and shape for child recognition and learning. The unique shapes may be a square, a circle, an oval, a parallelogram, a triangle, a trapezoid, a pentagon, a hexagon, an octagon, a diamond, or other suitable shape.

A kit is also disclosed herein including a plurality of flexible fabric sheets and a set of instructions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an educational toy system, constructed and operative according to the teachings of the present disclosure.

FIG. 1 is a perspective view of the educational toy system during an ‘in-use’ condition, according to an embodiment of the disclosure.

FIG. 2 is a perspective view of the educational toy system of FIG. 1, according to an embodiment of the present disclosure.

FIG. 3 is a perspective view of the educational toy system of FIG. 1, according to an embodiment of the present disclosure.

FIG. 4 is a perspective view of the educational toy system of FIG. 1, according to an embodiment of the present disclosure.

FIG. 5 is a flow diagram illustrating a method of use for the educational toy system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to educational devices and more particularly to an educational toy system as used to improve the teaching means for learning shapes, colors, symbols, and letters.

Generally, the educational toy system comprises various shapes which may include a square, a triangle, an octagon, a circle, a rectangle, a hexagon, an oval and a pentagon; other shapes may be used. These shapes are made from nylon, polyester, or other suitable material. The child or parent may say the letter, words, number, shape and or color. When the child holds up the letter another child may say it out loud so the other children can hear what he or she says and then she or she flips the fabric over and another child or all the children in the classroom say the number. This can also be done with the shapes and colors. The device may include a glue sealed or stitch sealed wire perimeter with vinyl heat press letters, symbols, numbers, punctuations, and directions.

A game may be played (method of play) by standing on the pieces of fabric and spelling words or doing math using the symbols and numbers in combination. The letter may include alphabet letters in English or other languages, the numbers may include two sets of numbers 0-9, words, and symbols such as +, &, #,?, =. Numbers may also include roman numerals, dots, or other numbering visuals. Symbols may include punctuation and words may include directions. The invention may include lights and sounds or other means for displaying. The educational toy system may further include grommets. The children can also place the fabric on the floor or ground and try to throw a beanbag on the fabric of a color or shape. The pieces of fabric may be used as agility objects to run around, jump, skip and hop over them. The shapes are two sided, with either a letter, number or symbol on each side. They will come in various colors. It should also be noted that, under appropriate circumstances, considering such issues as design preference, user preferences, marketing preferences, cost, structural requirements, available materials, technological advances, etc., other methods for educational toy system 100 (e.g., different step orders within above-mentioned list, elimination or addition of certain steps, including or excluding certain maintenance steps, etc.), are taught herein.

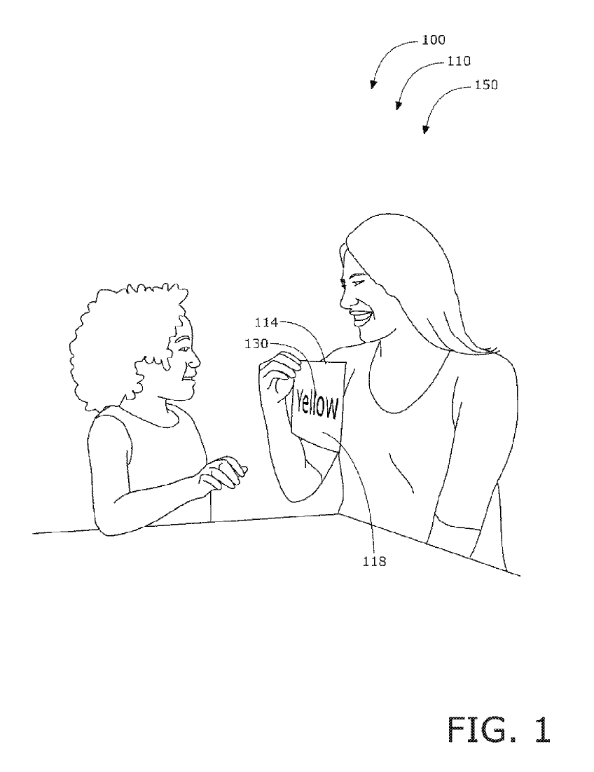

Referring now more specifically to the drawings by numerals of reference, there is shown in FIGS. 1-5, various views of an educational toy system 100. FIG. 1 shows an educational toy system 100 during an ‘in-use’ condition 150, according to an embodiment of the present disclosure. As illustrated, the educational toy system 100 may include a plurality of flexible fabric sheets 110 having indicia arranged in combination on at least one surface 114 structured and arranged to promote child recognition and for educational purposes. Each of the flexible fabric sheets 110 may comprise a front-surface 118 and a back-surface 120 and at least one side 122. The educational toy system 100 is configured for modular use of the plurality of flexible fabric sheets 110 such that each of the flexible fabric sheets 110, when strategically placed, can provide a child-based-query to provoke thought to form and relay an answer as to the child-based-query.

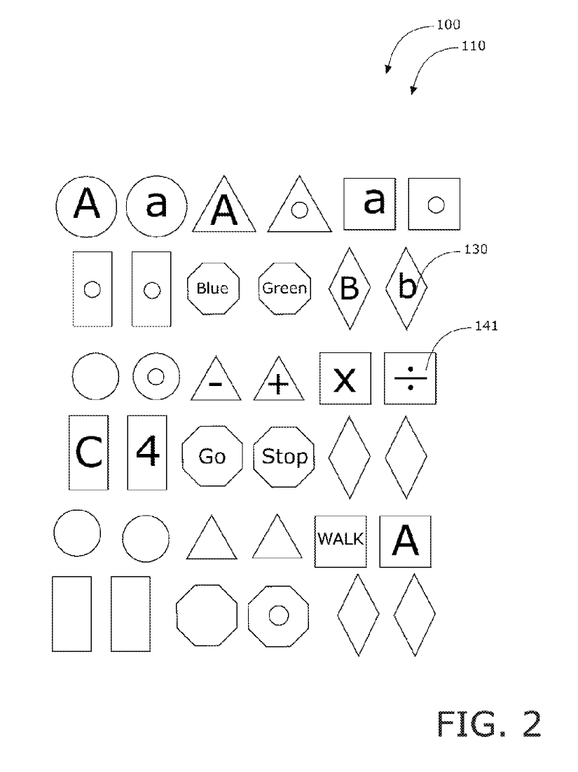

FIG. 2 shows a perspective view of the educational toy system 100 of FIG. 1, according to an embodiment of the present disclosure. As above, the educational toy system 100 may include a plurality of flexible fabric sheets 110 having indicia 130 arranged in combination on at least one surface 114 structured and arranged to promote child recognition and for educational purposes. Each of the flexible fabric sheets 110 includes indicia which may include at least one letter, at least one number, words, symbols or a combination thereof of for child recognition and the educational purposes. The flexible fabric sheets 110 may further comprise a unique color and shape for child recognition and learning. The unique shapes may be a square, a circle, an oval, a parallelogram, a triangle, a trapezoid, a pentagon, a hexagon, an octagon, a diamond, or other suitable shape.

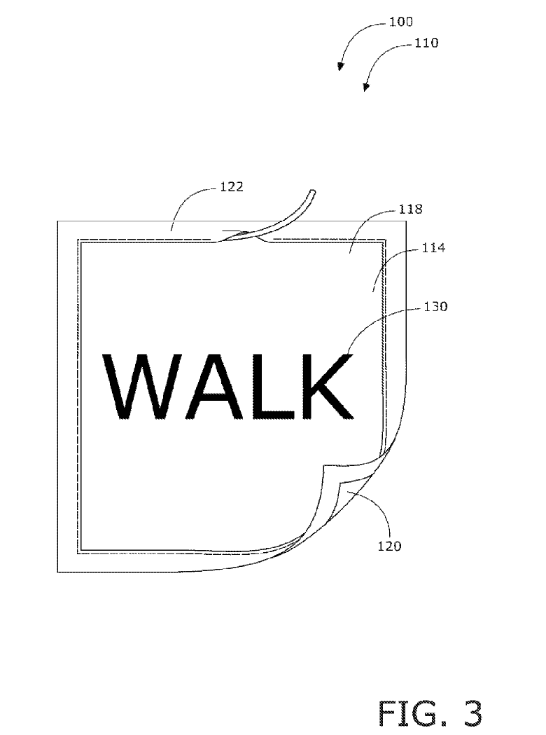

FIG. 3 shows a perspective view of the educational toy system 100 of FIG. 1, according to an embodiment of the present disclosure. As above, the educational toy system 100 may include a plurality of flexible fabric sheets 110 having indicia 130 for child recognition and use in play. The flexible fabric sheets 110 comprise a solid perimeter which may include rubber tubing, rope or wire positioned within a sleeve. In a preferred embodiment, the flexible fabric sheets 110 are washable. The flexible fabric sheets 110 may be stacked or spaced out. The flexible fabric sheets 110 are planar. The flexible fabric sheets 110 are double-sided in a preferred embodiment, and comprise the indicia 130 on both the front-surface 118 and the back-surface 120. The flexible fabric sheets 110 are configured to be used for games and as agility equipment.

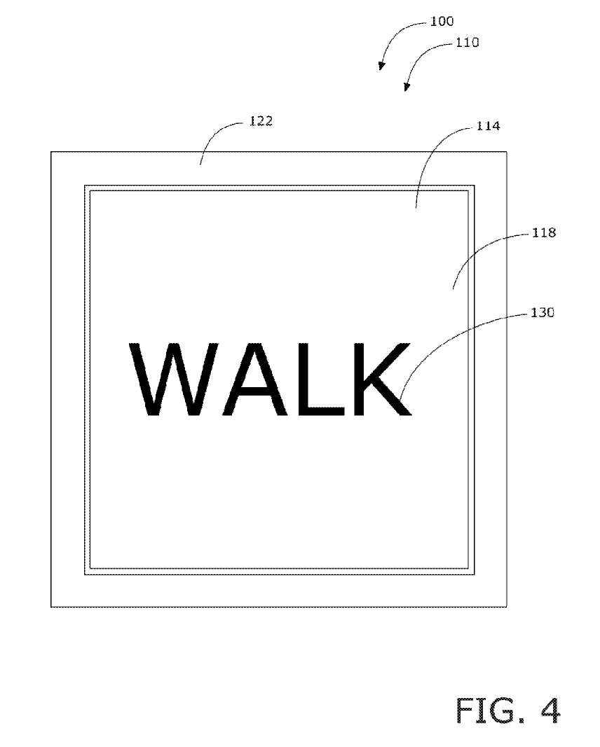

FIG. 4 shows a perspective view of the educational toy system 100 of FIG. 1, according to an embodiment of the present disclosure. As above, the educational toy system 100 may include plurality of flexible fabric sheets 110 having indicia 130 arranged in combination on at least one surface 114. The plurality of flexible fabric sheets 110 may be combined to create games for children and promote learning.

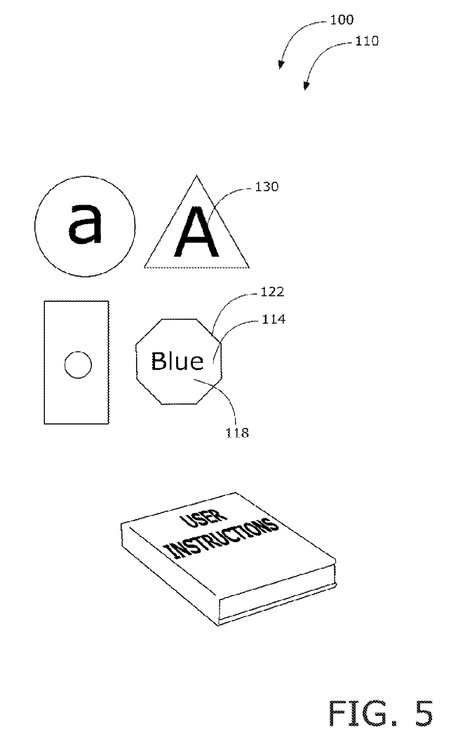

FIG. 5 shows a perspective view of the educational toy system 100 of FIG. 1, according to an embodiment of the present disclosure. As above, the educational toy system 100 may include a kit. According to one embodiment, the educational toy system 100 may be arranged as a kit. The kit may include a plurality of flexible fabric sheets 110, and a set of instructions. The instructions may detail functional relationships in relation to the structure of the educational toy system 100 (such that the educational toy system 100 can be used, maintained, or the like, in a preferred manner).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An educational toy system comprising:
a plurality of flexible fabric sheets having indicia arranged in combination on at least one surface structured and arranged to promote child recognition and for educational purposes;
wherein each of said flexible fabric sheets comprises a recognizable shape, each of said flexible fabric sheets comprising a front-surface and a back-surface and at least one side; and
wherein said educational toy system is configured for modular use of said plurality of flexible fabric sheets such that each of said flexible fabric sheets, when strategically placed, can provide a child-based-query to provoke thought to form and relay an answer as to said child-based-query.

2. The educational toy system of claim 1, wherein said flexible fabric sheets comprise said indicia including at least one letter.

3. The educational toy system of claim 1, wherein said flexible fabric sheets comprise said indicia including at least one number.

4. The educational toy system of claim 1, wherein said flexible fabric sheets comprise a unique color for said child recognition and said educational purposes.

5. The educational toy system of claim 1, wherein said flexible fabric sheets comprise a unique shape for said child recognition and said educational purposes.

6. The educational toy system of claim 5, wherein said unique shape is selected from a group consisting of a square, a circle, an oval, a parallelogram, a triangle, a trapezoid, a pentagon, a hexagon, an octagon, and a diamond.

7. The educational toy system of claim 1, wherein said flexible fabric sheets comprise a solid perimeter as said at least one side.

8. The educational toy system of claim 7, wherein said solid perimeter comprises rubber tubing.

9. The educational toy system of claim 7, wherein said solid perimeter comprises rope.

10. The educational toy system of claim 1, wherein said flexible fabric sheets are washable.

11. The educational toy system of claim 1, wherein said flexible fabric sheets are stackable.

12. The educational toy system of claim 1, wherein said flexible fabric sheets are double-sided and comprise said indicia on both of said front-surface and said back-surface.

13. The educational toy system of claim 1, wherein said indicia comprises words for said child recognition and said educational purposes.

14. The educational toy system of claim 1, wherein said indicia comprises symbols for said child recognition and said educational purposes.

15. The educational toy system of claim 1, wherein said flexible fabric sheets are configured to be used as agility equipment.

16. The educational toy system of claim 1, wherein said flexible fabric sheets are planar.

17. An educational toy system comprising:
a plurality of flexible fabric sheets having indicia arranged in combination on at least one surface structured and arranged to promote child recognition and for educational purposes;
wherein each of said flexible fabric sheets do not comprise a pocket and each comprises a recognizable shape, each of said flexible fabric sheets comprising a front-surface and a back-surface and at least one side;
wherein said flexible fabric sheets comprise said indicia including at least one letter;
wherein said flexible fabric sheets comprise said indicia including at least one number;
wherein said indicia comprises symbols for said child recognition and said educational purposes;
wherein said flexible fabric sheets comprises a unique color for said child recognition and said educational purposes;
wherein said flexible fabric sheets further comprises a unique shape for said child recognition and said educational purposes;
wherein said unique shape is selected from a group consisting of a square, a circle, an oval, a parallelogram, a triangle, a trapezoid, a pentagon, a hexagon, an octagon, and a diamond;
wherein said flexible fabric sheets comprise a solid perimeter as said at least one side;
wherein said flexible fabric sheets are washable;
wherein said flexible fabric sheets are planar;
wherein said flexible fabric sheets are stackable;
wherein said flexible fabric sheets are double-sided and comprise said indicia on both of said front-surface and said back-surface; and
wherein said educational toy system is configured for modular use of said plurality of flexible fabric sheets such that each of said flexible fabric sheets, when strategically placed, can provide a child-based-query to provoke thought to form and relay an answer as to said child-based-query.

18. The educational toy system of claim 17, further comprising a kit including:
said plurality of flexible fabric sheets;
a set of instructions; and
wherein the educational toy system is arranged as a kit.
